(19) United States
(12) Patent Application Publication
(10) Pub. No.: US 2018/0270282 A1
(43) Pub. Date: Sep. 20, 2018

(54) SYSTEM AND METHOD FOR TEMPORARY AND LOCAL CONTENT RELEASE

(71) Applicants: Airbus Operations GmbH, Hamburg (DE); Deutsche Telekom AG, Bonn (DE)

(72) Inventors: Nina Johnsen, Hamburg (DE); Torsten Chudobba, Neumunster (DE)

(21) Appl. No.: 15/919,617

(22) Filed: Mar. 13, 2018

(30) Foreign Application Priority Data
Mar. 14, 2017 (DE) 10 2017 204 216.8

(51) Int. Cl. H04L 29/06; H04N 21/254

(52) U.S. Cl. CPC H04L 65/4084; H04L 65/60; H04L 2463/101; H04L 63/0807; H04N 21/2541

(57) ABSTRACT

A method for temporary and local content release of digital data stored on a personal electronic device including a first personal electronic device authenticated on a server of an on-board entertainment system on board a transport structure or vehicle and a network connection between the authenticated first personal electronic device and the server is established. Media data stored on the first personal electronic device are transferred to the server over the network connection and are temporarily stored in a memory of the server. Some of the temporarily stored media data can be selected by a second personal electronic device, which is connected to the server over a network connection, and the selected media data are streamed from the server to the second personal electronic device.

### CROSS-REFERENCE TO RELATED APPLICATION

This application claims priority to German Patent Application DE 10 2017 204 216.8 filed Mar. 14, 2017, the entire disclosure of which is incorporated by reference herein.

### TECHNICAL FIELD

The disclosure herein relates to a system and to a method for temporary and local content release, in particular for use in networks of transport structures or vehicles.

### BACKGROUND

Personal electronic devices are becoming ever more common, and the devices are also often being used on board flights, boat journeys, bus journeys or train journeys on board the respective transport structure or vehicle. Passengers on aircraft or similar public transport structures or vehicles can for example purchase tickets or passes electronically, such that the purchased ticket is also delivered electronically in the form of a boarding pass or seat reservation together with corresponding access information. The wide variety of communication interfaces which modern electronic devices have means it makes sense to also allow passengers with these types of devices access to the network infrastructure of the transport structures or vehicles and therefore access to available equipment (e.g. entertainment media) when on board the transport structures or vehicles.

In addition to the primary purpose of a transport operator, such as an airline, which involves the transport of passengers and their luggage, the transport operator can offer passengers various services and entertainment options to improve their level of comfort during their journey. For example, the passengers may be offered digital entertainment content on board the transport structure or vehicle which can be used through the passengers' personal electronic devices, such as access to worldwide data networks, streaming of films and audio files such as audiobooks or music tracks, or similar items. Here, entertainment content of this type can be accessed by the passenger using their personal electronic device as a terminal.

The files that are digitally temporarily made available to the passenger in the process are in principle subject to copyright protection, i.e. measures relating to the playback of the content of the files need to be put in place that effectively prevent unauthorized access to or illegal copying of the files. For example, in order to control the use of digital media, what are known as digital rights management systems (DRM) can be used, by which technical security measures restrict the type of use of the digital property of copyright holders of information assets by users in accordance with desired user agreements.

U.S. Pat. No. 8,972,598 B2 discloses a method for providing digital content for passengers of a transport means on their devices which they have brought with them. US 2010/0138879 A1 discloses a vehicle-bound on-board entertainment system comprising a common memory device for all participating devices in the on-board entertainment network. US 2008/0141315 A1 discloses an on-board entertainment system on board a transport means in which passengers can communicate preferences for the media use of stored media files to the system in advance via an internet-based access system and can share these preferences with other passengers. US 2005/0044564 A1 discloses an on-board entertainment system for a commercial aircraft in which passengers can temporarily download media data onto their personal electronic devices and receive limited access thereto even if the network connection to the on-board entertainment system is interrupted.

### SUMMARY

One of the ideas of the present disclosure is to find solutions for making an entertainment system on board a public transport structure or vehicle more flexible.

In a first aspect, the present disclosure relates to a method for temporary and local content release of digital data stored on a personal electronic device, comprising authenticating a first personal electronic device on a server of an on-board entertainment system on board a transport structure or vehicle and of establishing a network connection between the authenticated first personal electronic device and the server. Media data stored on the first personal electronic device are transferred to the server over the network connection and are temporarily stored in a memory of the server. Some of the temporarily stored media data is selected by a second personal electronic device, which is connected to the server over a network connection, and the selected media data are streamed from the server to the second personal electronic device.

According to a second aspect, a server of an on-board entertainment system on board a transport structure or vehicle comprises a communication interface designed or configured to maintain network connections between the server and a plurality of personal electronic devices, a memory designed or configured to temporarily store digital media data, and a processor coupled to the memory and the communication interface. The processor is designed or configured to authenticate a first personal electronic device, to establish a network connection between the authenticated first personal electronic device and the server, to transfer media data stored on the first personal electronic device to the server over the network connection, to temporarily store the transferred media data in the memory, and to stream media data selected by a second personal electronic device, which is connected to the server over a network connection, to the second personal electronic device.

One of the concepts forming the basis for this disclosure herein involves temporarily loading content from passengers' personal electronic devices onto a central server of an on-board entertainment system on board a transport structure or vehicle, and making this content available to other passengers on board the transport structure or vehicle at least for the duration of the journey on the transport structure or vehicle. In the process, the content of passengers' personal electronic devices is only accessed for “content sharing” after the passenger consents to the content being released. Furthermore, only certain content that can be authenticated can be uploaded from the personal electronic devices to the central server as part of the “content sharing” approach, in order to ensure that the copyright of the content is protected.

By augmenting the content (e.g. films, TV programs, TV series, series produced by third-party suppliers, multimedia productions, audio files, audiobooks, music tracks and the like) stored on the central server of the on-board entertainment system in advance by the server operator with content brought on board by the passengers themselves, the size of the media library can be temporarily increased for the duration of the journey, without extensive updates needing to be carried out by the server operator. This improves the variety of entertainment content on offer to all the passengers on board the transport structure or vehicle, which in turn increases customer satisfaction.

It is particularly advantageous that the use of content from the devices brought on board by the passengers themselves does not require content to be stored in advance by the server operator before the start of the journey, but instead a temporary media library can be created on the fly. The passengers can be incentivized to agree to the use of their own content by each passenger being able to access other passengers' content in exchange for their own content for the duration of the journey. As a result, the passengers can be encouraged to collaborate with one another within a secure framework for reciprocal content release, without this requiring incentives from the server operator that go beyond the use of media content. In addition, the passengers each remain anonymous, since the server holds the passengers' uploaded media data in an anonymised manner, and other passengers who want to access this content during the journey do not receive any information whatsoever regarding the origin of the content.

It may be particularly advantageous for the access to other passengers' data content to extend beyond the end of the journey. For this purpose, temporarily limited or even permanent rights of use to the media data streamed during the journey can be granted by a rights supplier that has rights to the content of the media data, for example. In this regard, the passenger who is accessing the extended user-generated media library during the journey can purchase the media data or the rights of use to the media data through an appropriate third-party supplier for a fee.

According to some embodiments of the method, the transferred media data may be temporarily stored for the duration of a journey of the user of the first personal electronic device on the transport structure or vehicle. In some embodiments, the transferred media data may be temporarily stored in the memory of the server, for example using a caching or mirroring process. In some embodiments, the transferred media data may be deleted from the memory of the server once the journey is over. These measures can ensure that the media data made available by a passenger are only used within the scope of previously agreed terms of use, without any objections in relation to copyright. In particular, deleting the media data once a journey is over can create space for new media data from other passengers in the memory at the start of a new part of the journey of the transport structure or vehicle.

According to some other embodiments of the method, the transfer of the media data may only be carried out for the media data that have been released for transfer by a user of the first personal electronic device. This means that ultimate control over the media data remains with the passenger, who can only release the media data for other passengers following a request and optional consent to the temporary use of the media data.

According to some other embodiments of the method, before the released media data are transferred, the media data may be checked by the server for authenticity and existing authorization from the user for the media data to be used. In particular, this can ensure that only authorized users, for example passengers in possession of a valid ticket or boarding pass, can use the content release system. In addition, a third-party partner, such as a streaming portal, can carry out an authenticity and authorization check, since users also have to be authenticated and registered therein. According to some other embodiments of the method, for checking the media data by the server, an authenticity and authorization check can therefore be carried out by a media server from a third-party supplier to which the server maintains a data connection. This third-party supplier may for example be a supplier of entertainment products over the Internet, such as a streaming portal, a web hosting service or a video-on-demand service.

According to some other embodiments of the method, the network connections between the first and second personal electronic devices and the server may be wireless network connections.

According to some other embodiments of the method, the server may check that the users of the first and second personal electronic devices are authorized to be on board the transport structure or vehicle for the duration of a journey. In this way, the group of authorized users can remain limited to those passengers who can produce tickets or boarding passes.

According to some embodiments of the server, the processor may be designed or configured to only store the transferred media data for the duration of a journey of the user of the first personal electronic device on the transport structure or vehicle, and to delete the transferred media data from the memory once the journey is over.

According to some other embodiments of the server, the processor may be designed or configured to only transfer the media data to the server that have been released for transfer by a user of the first personal electronic device.

According to some other embodiments of the server, the communication interface may be a wireless communication interface that is designed or configured to establish wireless network connections between the personal electronic devices and the server.

According to some other embodiments of the server, the processor may be designed or configured to check that the users of the first and second personal electronic devices are authorized to be on board the transport structure or vehicle for the duration of a journey.

According to some other embodiments of the server, the processor may be designed or configured to render the media data streamed on the second personal electronic device permanently or at least temporarily usable for the user of the second personal electronic device beyond the end of the journey by suitable data release mechanisms. This opens up the option of time-limited use with the possibility of temporarily or permanently purchasing the rights of use to the media data. For example, this can also constitute an incentive for the passengers providing the content if their provision of the media data is triggered during the journey to create a transaction for the third-party supplier and the holder of the rights of use.

In some aspects of the present disclosure, the server may be implemented on board a passenger aircraft.

The above-mentioned embodiments and developments can be combined in any manner, if appropriate. Further possible configurations, developments and implementations of the disclosure herein also comprise not explicitly mentioned combinations of features of the disclosure herein described previously or in the following with respect to the embodiments. In particular, a person skilled in the art will also add individual aspects as improvements or supplements to the relevant basic form of the present disclosure.

### BRIEF DESCRIPTION OF THE DRAWINGS

The present disclosure will be described in greater detail below with reference to the embodiments shown in the schematic, example drawings, in which:

FIG. 1 is a schematic view of a network environment of a server of an on-board entertainment system for a transport structure or vehicle according to an embodiment of the disclosure herein;

FIG. 2 is a schematic block diagram of stages of a method for temporary and local content release according to another embodiment of the disclosure herein;

FIG. 3 is a schematic flow chart of network nodes involved in a method for temporary and local content release according to another embodiment of the disclosure herein; and

FIG. 4 is a schematic diagram of a passenger aircraft, comprising the network environment shown in FIG. 1, according to another embodiment of the disclosure herein.

The accompanying drawings are intended to facilitate further understanding of the embodiments of the disclosure herein. The drawings illustrate embodiments and, together with the description, serve to explain principles and concepts of the disclosure herein. Other embodiments and many of the advantages mentioned can be found with reference to the drawings. The elements of the drawings are not necessarily shown to scale relative to one another. Terms specifying direction, such as “upper”, “lower”, “left”, “right”, “above”, “below”, “horizontal”, “vertical”, “front”, “rear” and similar details are used merely for explanatory purposes and are not intended to restrict the generality to specific embodiments as shown in the drawings.

In the figures of the drawings, identical, functionally identical and identically operating elements, features and components are in each case provided with the same reference signs, unless indicated otherwise.

### DETAILED DESCRIPTION

Personal electronic devices (PEDs) in the context of the present disclosure include all electronic apparatuses which can be used for the purpose of entertainment, communication and/or office work. For example, PEDs can include all types of consumer devices, such as laptops, mobile phones, smartphones, handheld devices, palmtop PCs, tablet PCs, GPS devices, navigation devices, audio equipment such as MP3 players, portable DVD/Blu-ray® players or digital cameras.

Media data in the context of the present disclosure include any digital representation of content that can be played back as media on digital reproduction devices, in particular on PEDs. Media data in the context of the present disclosure can in particular include digital files of audiobooks, films, music tracks, e-books, TV series, film productions with at least two episodes of extensive fictional or fact-oriented action, series produced by third-party suppliers, multimedia productions, digital images and similar digital entertainment products.

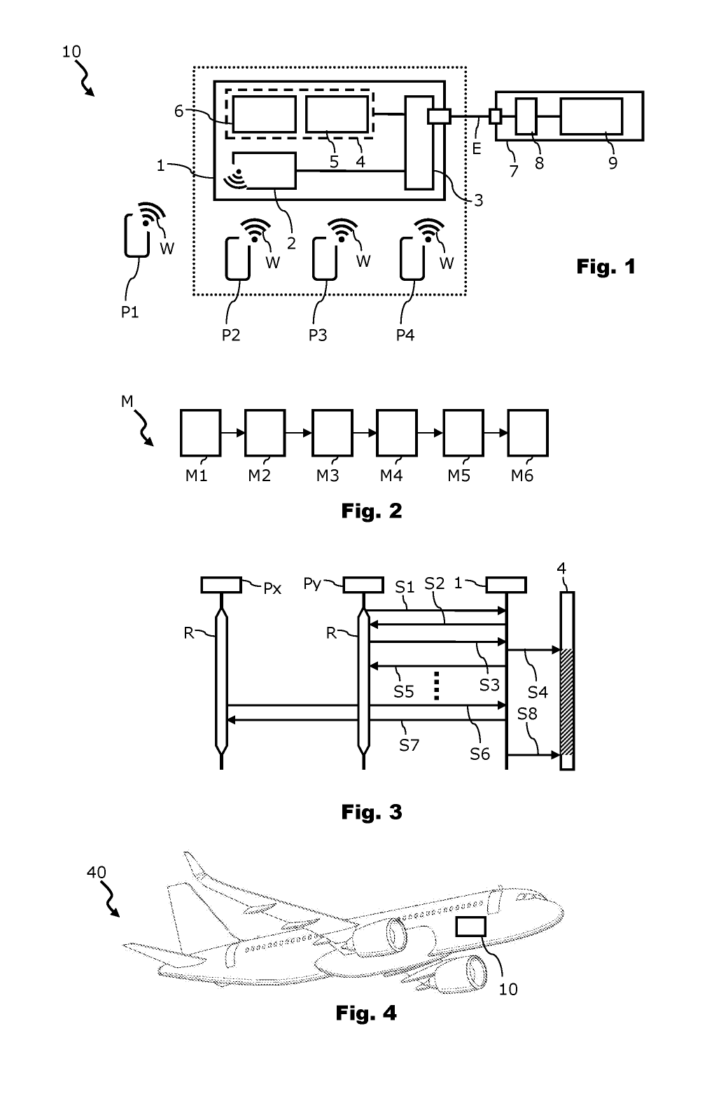

FIG. 1 is a schematic view of a network environment 10 in a transport structure or vehicle. In this case, the transport structure or vehicle may for example be a passenger aircraft 40, as shown in FIG. 4 by way of example. Of course, however, the network environment 10 may also be used in conjunction with other transport structures or vehicles, such as long-distance trains, local trains, buses, coaches, underground trains, trams, ferries, cruise liners, boats or the like.

In this case, the network environment 10 is implemented at least in part on board a transport structure or vehicle, such as the passenger aircraft 40 in FIG. 4. The physical extent of the network environment 10 to be included in the region of the interior of the transport structure or vehicle is indicated by the dotted line in FIG. 1. As a result of the network environment 10 being made up at least in part of temporary network participants that are connected to other network participants over wireless network connections W, the network environment 10 can also extend to regions outside the interior of the transport structure or vehicle that are at least in close proximity to the interior. Examples of local surrounding regions of this type may be gates at airport terminals, platforms, passenger waiting areas for travellers in transit, or the like. By way of example, FIG. 1 shows three PEDs P2, P3 and P4 as being on board the transport structure or vehicle, i.e. within the dotted line, while another of the PEDs, P1, may be located in a local surrounding region of the transport structure or vehicle.

The network environment 10 comprises a central server 1 of an on-board entertainment system on board the transport structure or vehicle. The central server 1 comprises a processor 3, a communication interface 2 coupled to the processor 3, and a memory 4 for media data that is coupled to the processor 3. Entertainment content 5 stored in advance by the server operator of the server 1 can be held in the memory 4, for example. In addition, media data that have been released to the server operator for temporary use from personal electronic devices (PEDs) P1, P2, P3, P4 by passengers on the transport structure or vehicle and are uploaded to the server 1 can be temporarily stored in the memory 4, for example in a dedicated memory region 6.

Optionally, the processor 3 may be connected to a third-party supplier's media server 7 via an external interface E. In this case, the processor 3 can communicate with a processor 8 of the media server 7, for example for the purpose of authenticating passengers whose PEDs P1, P2, P3, P4 establish a wireless and/or wired network connection W to the server 1 via the communication interface 2. In this case, the third-party supplier's media server 7 may have a database 9, for example, in which authorization information for the PEDs P1, P2, P3, P4 and the associated passengers can be stored. Here, it may be possible for the media server 7 itself to carry out an authentication and authorization check of a user of a PED P1, P2, P3, P4 seeking to establish a network connection via the communication interface 2, and for the server 1 to only convey information as a middleman when transmitting the messages required for the authentication and authorization check between the media server 7 and the PED P1, P2, P3, P4. In addition, it may alternatively also be possible for the user of the PED P1, P2, P3, P4 to establish a direct connection to the media server 7 that is not carried out by the server 1 over a network connection, in order to carry out an authentication and authorization check directly on the media server 7. The user of the PED P1, P2, P3, P4 can log into the server 1 using an accordingly issued authorization token that is made available to the user of the PED P1, P2, P3, P4 by the media server 7. For this purpose, the authorization token can provide the server 1 with information for a comparison with corresponding authorization and registration information from a database 9 of the media server 7.

The communication interface 2 may for example be a wireless communication interface 2, as shown in FIG. 1, by which the wireless network connections W between the server 1 and various PEDs P1 to P4 can be established. Here, the wireless communication interface 2 can also be arranged outside the server 1, for example as an access point of a wireless network of the transport structure or vehicle. In this case, the server 1 can be in communication with the communication interface of the wireless network of the transport structure or vehicle by another connection, for example a wired connection. It is of course also possible to provide a solely wired communication interface 2 by which the various PEDs P1 to P4 can establish wired network connections W to the server 1.

The communication interface 2 is designed or configured to establish and maintain network connections between the PEDs P1 to P4 and the server 1. For wireless network connections, it is not strictly necessary for the PEDs to be in the interior of the transport structure or vehicle (as is the case for the PEDs P2 to P4 in FIG. 1), but instead a local surrounding region can be covered by the wireless network connections. For example, a PED P1 that is located in an airport gate region close to a passenger aircraft 40 can establish a wireless network connection to a communication interface 2 of a server 1 implemented in the passenger aircraft 40. For this purpose, additional technical equipment that extends connectivity can also be provided outside the interior of the transport structure or vehicle in the local surrounding regions of the server 1, this being such equipment as repeaters, additional access points or other technical devices for boosting the reception of the wireless network.

It may also be possible for the PEDs P1 to P4 to be able to release media data for temporary upload to the server 1 by communication with the media server 7 of a third-party supplier even before a journey begins and before the PEDs enter the local access region of the server 1. As a result, media data can be temporarily stored on the server 1 by registered and authenticated users in advance, before the user actually establishes a local network connection W to the server 1 using their PED. This advantageously allows the load on the server 1 to be equalised when transferring the media data from many PEDs that are potentially accessing the server 1 and providing media data for transfer almost simultaneously (specifically at the start of the journey).

FIG. 2 is a block diagram of steps of a method M for local and temporary content release of media data made available to a server of an on-board entertainment system on board a transport structure or vehicle by passengers via their personal electronic devices (PEDs). The method M in FIG. 2 is explained here in greater detail with reference to the flow chart shown by way of example in FIG. 3. In this case, the method M in FIG. 2 can be carried out by the network environment 10 explained in conjunction with FIG. 1, in particular on board a passenger aircraft 40, as shown by way of example in FIG. 4.

In a first step M1 of the method M, a first personal electronic device is authenticated on a server 1 of an on-board entertainment system on board a transport structure or vehicle. The authentication can for example be carried out by a personal electronic device Py making a login request S1 to the server 1, which determines the identity of the personal electronic device Py and the user thereof and grants the personal electronic device Py a release for using the network in a response S2. In step M2, it is made possible for the authenticated first personal electronic device Py to establish a network connection to the server 1. In this case, the network connection may be a wireless network connection, which can communicate via connectivity features of both the PEDs Py and the wireless communication interface 2 of the server 1.

During authentication, the server 1 can for example determine whether the user of the first personal electronic device Py is authorized to be on board the transport structure or vehicle 40 for the duration of a journey. For this purpose, the server 1 can for example retrieve information relating to a booked ticket or a boarding pass from the first personal electronic device Py or can request a journey booking number stored by a booking service, and can compare this information with authorization information stored in a central booking database.

The steps of authentication and connecting to the network can be carried out at the start of a journey R on a transport structure or vehicle. In this case, the start of a journey R may be a point in time, determined by an operator of the transport structure or vehicle, at which preparations for the actual journey begin. For a passenger aircraft, this point in time may be the time at which a gate opens for passengers to board the aircraft, for example. In other cases, the start of the journey R may also include time periods in which physical preparations of the transport structure or vehicle have not yet begun, but in which the passenger just has a firm booking for the journey R. Therefore, media data can also be transferred or released by the passenger in advance for temporary use during the journey R, for example using an electronic application on the PED.

In a transfer process S3, according to step M3 of the method, media data stored on the first personal electronic device Py can then be transferred to the server 1 over the network connection. In step M4, the transferred media data are temporarily stored in a memory 4 of the server 1 in a storage process S4, for example using a caching or mirroring process. By temporarily storing a large amount of media data from different PEDs participating in the network, a temporary, user-based media database can thus be created in the memory 4 to which all PEDs on board the transport structure or vehicle can be granted access during the journey.

Of course, only the media data for which the user of the personal electronic device Py has given a release can be temporarily stored in the memory 4. Furthermore, for security reasons, only the media data that have been checked for authenticity and existing authorization from the user for the media data to be used prior to being transferred to the server 1 can be transferred. For example, the server 1 may send metadata for the released media data to a third-party supplier's media server 7 via an external interface E. The media server 7 then carries out an authenticity and authorization check for the requested media data, and grants the server 1 a release for the transfer and temporary storage of the user's media data from their personal electronic device Py.

The temporary media database created in this way can now be accessed both by the user of the personal electronic device Py in a streaming process S5 and also by users of other personal electronic devices Px. These users first have to connect to the server 1 in a connection process S6, for example by establishing a wireless and/or wired network connection to the communication interface 2. To do this, the user has to have the required authorization to establish a network connection, and this can be checked by a login process together with a registration procedure on the server 1 or by using a registration procedure outsourced to a third-party supplier's server 7. The users of the other personal electronic devices Px can then view a catalogue of the content available in the temporary media database and select some of the media data in a step M5 of the method M.

As indicated in processes S5 and S7 in FIG. 3, the selected media data can be streamed to the relevant personal electronic device Px or Py by the server 1. Streaming in the context of the present disclosure can include simultaneous transfer and playback of media data over the network connection established between a PED and the server. By contrast with a conventional data transfer process, in this process streamed data are not put onto the PED as a copy, but instead are directly (i.e. virtually in real time) output by playback devices such as speakers, headphones or displays of the PEDs, and are then discarded from the PED again immediately or at least after a time period that cannot be influenced by the user of the PED.

The server's streaming service, the temporarily created media database of entertainment content made available by users, can be used by the PEDs at least for the duration of the journey R. The point in time marking the end of the journey R can likewise be determined by the server operator of the server 1, for example an airline. For example, it may be possible to determine a transition time period after the actual end of the journey (e.g. arrival at a destination, a destination airport or a destination train station) during which the travellers can still use the transferred media data. For this purpose, the media data can be digitally tagged with time stamps and corresponding expiry information in order to put a time limit on how long the PED can use the data.

Once the journey is over, in a deleting process S8, the server 1 itself has to ensure that all transferred media data are deleted from the memory 4 of the server 1 once the journey R is complete.

In the detailed description above, various features have been summarised in one or more examples so as to provide a more cogent representation. However, it should be clear here that the above description is of a purely illustrative, but in no way limiting nature. The description serves to cover all alternatives, modifications and equivalents of the various features and embodiments. Many other examples will become immediately clear to a person skilled in the art owing to their expert knowledge in view of the above description.

The embodiments have been selected and described in order to be able to show, as clearly as possible, the principles on which the disclosure herein is based and the possible applications thereof in practice. As a result, persons skilled in the art can optimally modify and use the disclosure herein and the various embodiments thereof with respect to the intended purpose thereof. In the claims and the description, the terms “containing” and “comprising” are used as linguistically neutral terminology for the corresponding term “including”. Furthermore, use of the terms “a”, “an” and “one” is not intended to fundamentally exclude a plurality of such described features and components.

The subject matter disclosed herein can be implemented in software in combination with hardware and/or firmware. For example, the subject matter described herein can be implemented in software executed by a processor or processing unit. In one exemplary implementation, the subject matter described herein can be implemented using a computer readable medium having stored thereon computer executable instructions that when executed by a processor of a computer control the computer to perform steps. Exemplary computer readable mediums suitable for implementing the subject matter described herein include non-transitory devices, such as disk memory devices, chip memory devices, programmable logic devices, and application specific integrated circuits. In addition, a computer readable medium that implements the subject matter described herein can be located on a single device or computing platform or can be distributed across multiple devices or computing platforms.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for temporary and local content release of digital data stored on a personal electronic device, comprising:
authenticating a first personal electronic device on a server of an on-board entertainment system on board a transport structure;
establishing a network connection between the authenticated first personal electronic device and the server;
transferring media data stored on the first personal electronic device to the server over the network connection;
temporarily storing the transferred media data in a memory of the server;
selecting some of the temporarily stored media data by a second personal electronic device, which is connected to the server over a network connection; and
streaming the selected media data from the server to the second personal electronic device.

2. The method of claim 1, wherein the transferred media data are temporarily stored for a duration of a journey of a user of the first personal electronic device on the transport structure, and the transferred media data are deleted from the memory of the server once the journey is over.

3. The method of claim 1, wherein the transfer of the media data is only carried out for the media data that have been released for transfer by a user of the first personal electronic device.

4. The method of claim 3, wherein, before the released media data are transferred, the media data are checked by the server for authenticity and existing authorization from the user for the media data to be used.

5. The method of claim 4, wherein, for checking the media data by the server, an authenticity and authorization check is carried out by a media server from a third-party supplier to which the server maintains a data connection.

6. The method of claim 1, wherein the network connections between the first and second personal electronic devices and the server are wireless network connections.

7. The method of claim 1, wherein the network connections between the first and second personal electronic devices and the server are wired network connections.

8. The method of claim 1, wherein the server checks that users of the first and second personal electronic devices are authorized to be on board the transport structure for the duration of a journey.

9. A server of an on-board entertainment system on board a transport structure, comprising:
a communication interface configured to maintain network connections between the server and a plurality of personal electronic devices;
a memory configured to temporarily store digital media data; and
a processor that is coupled to the memory and the communication interface and is configured to authenticate a first personal electronic device, to establish a network connection between the authenticated first personal electronic device and the server, to transfer media data stored on the first personal electronic device to the server over the network connection, to temporarily store the transferred media data in the memory, and to stream media data selected by a second personal electronic device, which is connected to the server over a network connection, to the second personal electronic device.

10. The server of claim 9, wherein the processor is configured to only store the transferred media data for a duration of a journey of a user of the first personal electronic device on the transport structure, and to delete the transferred media data from the memory once the journey is over.

11. The server of claim 9, wherein the processor is configured to only transfer the media data to the server that have been released for transfer by a user of the first personal electronic device.

12. The server of claim 9, wherein the communication interface is a wireless communication interface that is configured to establish wireless network connections between the personal electronic devices and the server.

13. The server of claim 9, wherein the communication interface is a wired communication interface that is configured to establish wired network connections between the personal electronic devices and the server.

14. The server of claim 9, wherein the processor is configured to check that users of the first and second personal electronic devices are authorized to be on board the transport structure for a duration of a journey.

15. The server of claim 9, wherein the processor is also configured to render the media data streamed on the second personal electronic device permanently or at least temporarily usable for a user of the second personal electronic device beyond an end of the journey by suitable data release mechanisms.

16. The server of claim 9, wherein the processor is also configured to temporarily store the transferred media data in the memory using a caching process.

17. The server of claim 9, wherein the processor is also configured to temporarily store the transferred media data in the memory using a mirroring process.

18. A passenger aircraft, comprising a server, the server comprising:
a communication interface configured to maintain network connections between the server and a plurality of personal electronic devices;
a memory configured to temporarily store digital media data; and
a processor that is coupled to the memory and the communication interface and is configured to authenticate a first personal electronic device, to establish a network connection between the authenticated first personal electronic device and the server, to transfer media data stored on the first personal electronic device to the server over the network connection, to temporarily store the transferred media data in the memory, and to stream media data selected by a second personal electronic device, which is connected to the server over a network connection, to the second personal electronic device.
